(19) United States
(12) Patent Application Publication
(10) Pub. No.: US 2014/0228129 A1
(43) Pub. Date: Aug. 14, 2014

(54) SERVER DATA UPDATE METHOD AND SYSTEM

(71) Applicant: Tencent Technology (Shenzhen) Company Limited, Shenzhen (CN)

(72) Inventor: Dong WANG, Shenzhen (CN)

(73) Assignee: Tencent Technology (Shenzhen) Company Limited, Shenzhen (CN)

(21) Appl. No.: 14/259,017

(22) Filed: Apr. 22, 2014

Related U.S. Application Data
(63) Continuation of application No. PCT/CN2013/087805, filed on Nov. 26, 2013.

(30) Foreign Application Priority Data
Nov. 27, 2012 (CN) 201210490422.2

(51) Int. Cl. H04L 12/911; A63F 13/30

(52) U.S. Cl. CPC H04L 47/70; A63F 13/12
USPC 463/42; 709/224

(57) ABSTRACT

A method of updating a server is provided. Maintenance of a primary server is initiated. The primary server serves a first group of users comprising one or more users having an active status, and a second group of users having an idle status. Data is mapped from the primary server to an alternate server, the data including instructions for providing an online service. Each user in the second group is migrated to the alternate server upon initiation of the maintenance. The online service is provided to each user of the first group via the primary server until a time when the user discontinues the online service. The user is then migrated to the alternate server. When each user from the first and second groups has been migrated to the alternate server, a server update procedure is initiated. The maintenance is performed on the primary server during the server update procedure.

### RELATED APPLICATIONS

This application is a continuation application of PCT Patent Application No. PCT/CN2013/087805, entitled “SERVER DATA UPDATE METHOD AND SYSTEM” filed Nov. 26, 2013, which claims priority to Chinese Patent Application No. 201210490422.2, entitled “SERVER DATA UPDATE METHOD, AND SYSTEM,” filed Nov. 27, 2012, both of which are herein incorporated by reference in their entirety.

### FIELD OF THE INVENTION

The disclosed implementations relate generally to the technical field of communications, and in particular, to a server data update method, and system.

### BACKGROUND OF THE INVENTION

A server provides various services for users, and a large amount of data interaction exists between the server and its users. However, the server generally has various situations requiring data update, such as system updating, server version update, and periodic maintenance.

Currently, server data update generally adopts the following two solutions. One is shutting down a system for maintenance, and the other is refusing to provide services for new clients, and after providing services for clients having entered the server, shutting down the system for maintenance. A server providing game services is taken as an example for illustration as follows.

The system down for maintenance is specifically that: players are notified before the system down that the server will be maintained in a certain period of time, and an operation and maintenance engineer shut down the server in the period of time. Because the system is shut down, new players cannot enter the server in this period of time, and players having entered the server are sent out of the server. After the server is shut down, the server starts updating, and after the updating is completed, the server restarts and allows players to enter, and starts to provide game services for users again.

The other manner is specifically that: when the server prepares to be updated, new players are not allowed to enter the server; players having entered the server and being in game can play games normally; and players having finished the game are not allowed to start new games. After all players entered the server finish the games, the server send out all the players, and the server is shut down. After the server is shut down, the server starts updating, and after the updating is completed, the server restarts and allows players to enter, and starts to provide game services for users again.

As for the above two solutions, in the first solution, players playing games are disconnected to the services forcibly during the operation and maintenance engineer shuts down the server, and the games are dismissed forcibly, which influences normal game benefits of the players, and damages the user experiences; in the second solution, when the server performs site-clearing, new players cannot enter the server, and the players having entered the server cannot start new games, moreover, because it is required to wait until all players in the server finish their games, the whole updating time is long, and the user experiences are damaged during the long time updating.

The data update of the server providing game services is taken as an example for illustration in the above, and it should be noted that, the above example is only a specific example of an application scenario of a server providing services for users, and a person skilled in the art should understand that, services provided by the server to users are diversified, and scenarios thereof are correspondingly diversified, the application cannot list all of them, so the above example should not be understood as a limit on the scope of the technical solution provided by this application.

It can be seen from the above example that, no matter which one of the two solutions is adopted, the server data update is not smooth enough, and causes service interruption of the server on the users, so that the user experiences are poor.

### SUMMARY

To address the aforementioned problems, some implementations of the present application provide a computer-implemented method of updating a server that provides an online service to users. The method includes initiating maintenance of a primary server. The primary server serves, at a time when the maintenance is initiated, a first group of users comprising one or more users having an active status, the active status indicating that a user is logged on to the primary server and is actively utilizing an online service provided by the primary server, and a second group of users having an idle status, the idle status indicating that a user is logged on to the primary server and is not utilizing the online service provided by the primary server. Data is mapped from the primary server to an alternate server, the data including instructions for providing the online service. At the time when the maintenance is initiated, each user in the second group of users is migrated to the alternate server. For each respective user in the first group of users, the online services are provided to the respective user via the primary server until a time when the respective user discontinues the online service. At the time when the respective user discontinues the provided service, the respective user is migrated to the alternate server. When each of the users from the first group of users and the second group of users has been migrated to the alternate server, a server update procedure is initiated. The maintenance is performed on the primary server during the server update procedure.

In another aspect of the present application, to address the aforementioned problems, some implementations provide a non-transitory computer readable storage medium storing one or more programs. The one or more programs comprise instructions, which when executed by a server system with one or more processors and memory, cause the server system to perform any of the methods provided herein.

In yet another aspect of the present application, to address the aforementioned problems, some implementations provide a server system. The server system includes one or more processors, memory, and one or more programs. The one or more programs are stored in memory and configured to be executed by the one or more processors. The one or more programs include an operating system and instructions that when executed by the one or more processors cause the server system to perform any of the methods provided herein.

### BRIEF DESCRIPTION OF THE DRAWINGS

For a better understanding, reference should be made to the following detailed description taken in conjunction with the accompanying drawings, in which:

FIG. 1 is a schematic flow chart of a method, in accordance with some embodiments.

FIG. 2 is a schematic flow chart of a method for processing a player not logging in and not initiating a service request, in accordance with some embodiments.

FIG. 3 is a schematic flow chart of a method for processing a player having logged in but not using a service, in accordance with some embodiments.

FIG. 4 is a schematic flow chart of a method for processing a player having logged in and using a service, in accordance with some embodiments.

FIG. 5 is a schematic structural diagram of a device, in accordance with some embodiments.

FIG. 6 is a schematic structural diagram of another device, in accordance with some embodiments.

FIGS. 7A-7C are schematic flowcharts of a method for updating a server, in accordance with some embodiments.

FIG. 8 is a diagram of a client-server environment for server updates, in accordance with some implementations.

FIG. 9 is a block diagram illustrating a server system, in accordance with some implementations.

FIG. 10 is a block diagram illustrating a client device, in accordance with some implementations.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

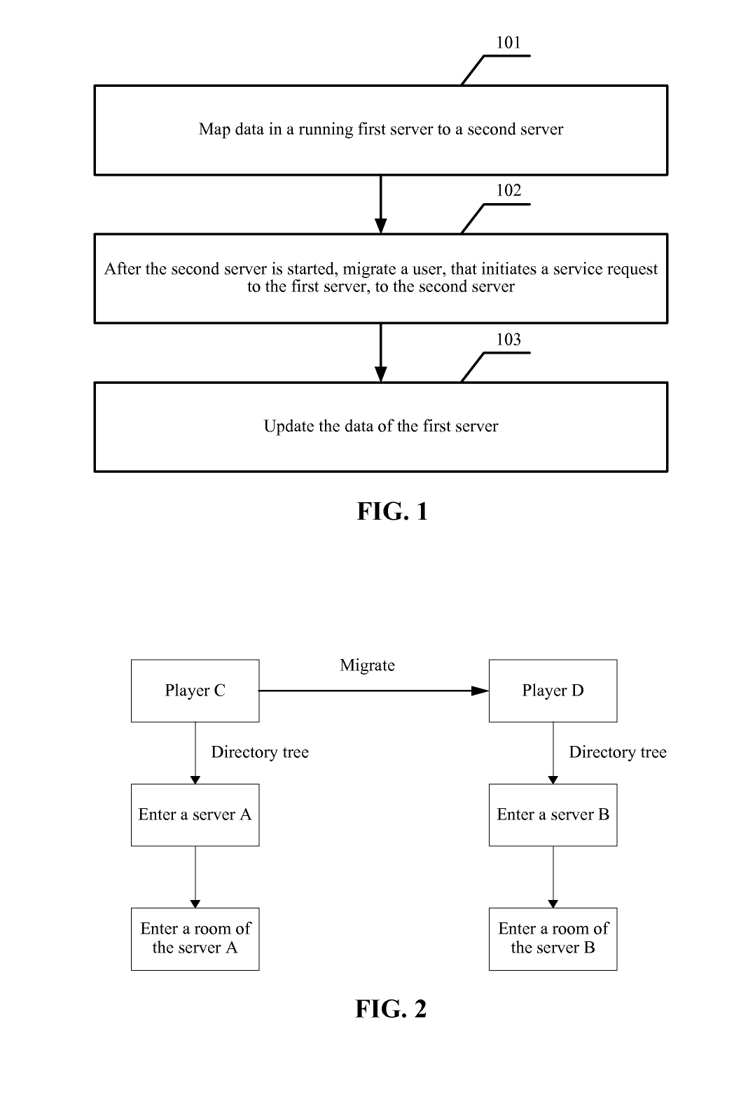

An embodiment of the present application provides a server data update method, as shown in FIG. 1, which includes:

101: Map data in a running first server to a second server.

The mapping may be a procedure of copying all record data on the second server to the second server.

102: After the second server is started, migrate a user, which initiates a service request to the first server, to the second server.

The step 102 may implement that a user not logging in the first server can normally obtain a service when initiating login, and the embodiment of the present application further provides a processing manner for a user having logged in the first server: after the second server is started, the method further includes: migrating the user having logging in the first server to the second server. The solution enables that a service of the user having logged in is not interrupted, so that the data update is smooth, and the user experience is better. Moreover, the embodiment of the present application provides two types of processing manners for the migrating manner.

The migration of the user having logged in the first server to the second server includes that: if the user has logged in the first server but does not actively use a service, the user is directly migrated to the second server. The solution enables that a service of the user having logged in but not using a service is not interrupted, so that the data update is smooth, and the user experience is better.

The migration of the user having logged in the first server to the second server includes that: if the user has logged in the first service and is using the service, the user is migrated to the second server after the service provided by the first server is finished. The solution enables that a service of the user having logged in and using the service is not interrupted, so that the data update is smooth, and the user experience is better.

Subsequent embodiments make more detailed illustrations on the two types of manners through examples.

An embodiment of the present application further provides a specific implementation for migrating a user having logged in the first server, which is described as follows. The migration of the user having logged in the first server to the second server includes that: the user is migrated to a service module in the second server being the same as that in the first server, and the user exits from the first server.

103: Update the data of the first server.

In the above solution, by mapping data in a first server to a second server, and migrating a user, which initiates a service request to the first server, to the second server, the second server is enabled to provide a service for the user, and for a user newly initiating a service, the service is not interrupted, so the data update is smooth, and the user experience is better.

An embodiment of the present application further provides a specific implementation of updating data of the first server, specifically: in the step 103, the updating the data of the first server includes: after all users in the first server are migrated to the second server, closing all services of the first server, and starting data update.

The above embodiment has three steps sequentially being: data backup, user migration, and data update. The three parts are illustrated through examples respectively in the following embodiment. The part of user migration is specifically illustrated through examples of three types of user migration including: not logging in and not initiating a service request, having logged in but not using a service, and having logged in and using a service.

It is assumed that a server A is a server requires data update, and the data update is software update. The server A is currently providing a service for users, the provided service is a game service, and a server B is another server. It should be noted that, the game service is only one of various possible services, and any other service that is obtained through data interaction between the user and the server is available, which is not limited in the embodiment of the present application, and the above example should not be considered as a limit to the embodiment of the present application.

The data backup in the embodiment of the present application is that: before the server A performs software updating, data of the server A is mapped to the server B, and a new software version can be deployed in the server B. Rooms on the server B are one-to-one corresponding to rooms on the server A.

The processing on a player not logging in and not initiating a service request is shown in FIG. 2.

Before migration:

Rooms visible by a player on a directory tree (a visible interface at the user side) are the rooms on the server A, for example, after a new player C enters the server A, the player C enters a room of the server A.

After migration:

Rooms visible by a player on a directory tree are the rooms on the server B, for example, a new player D enters the server B through the directory tree, and enters a room of the server B.

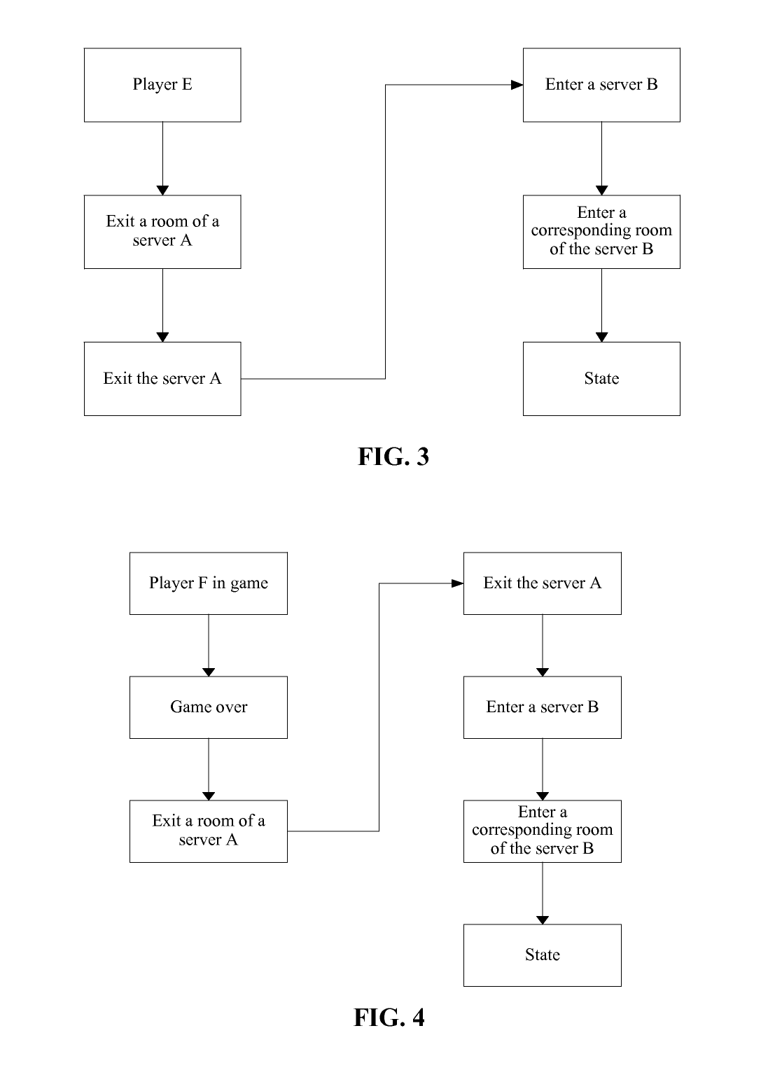

The processing on a player having logged in but not using a service is shown in FIG. 3.

An idle player or a player E ready for a game (not starting a game) that is originally in a room of the server A is automatically migrated to a corresponding room of the server B by the server A, specifically:

The player E having logged in but not starting a game;

Exit a room of the server A;

Exit the server A;

Enter the server B;

Enter a room in the server B that is corresponding to the room in the server A of the player E; and

Set a state (a state such as waiting and ready) of the player E as a state the same as that on the server A.

The processing on a player having logged in and using a service is shown in FIG. 4.

A player in game in a room on the server A plays the game normally on the server A, until the game is over. After the game is over, the player is migrated from the server A to a corresponding room of the server B. The specific flow may be as follows:

A player F in game plays the game normally;

The current game of the player F is over;

Exit the room of the server A;

Exit the server A;

Enter the server B;

Enter a room in the server B corresponding to the room in the server A of the player F; and

Set a state (a state such as waiting and ready) of the player E as a state the same as that on the server A.

According to the above solution, after all players on the server A finish games, all players having logged in the server A are migrated to the server B, and then the server A can be shut down. The server A that is shut down can finish all software updating. The server can execute the above solution once again, so as to migrate all players from the server B to the server A.

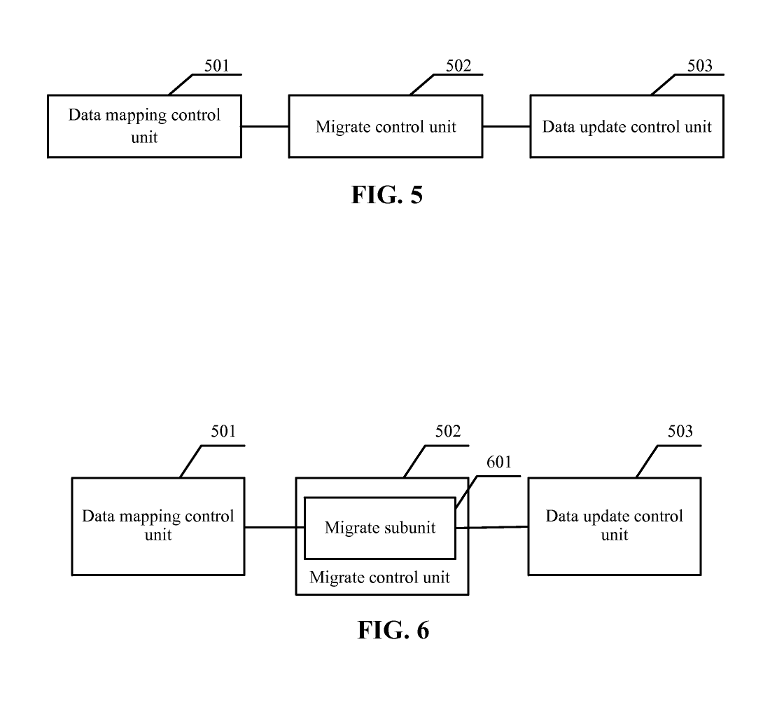

An embodiment of the present application further provides a server data update device, as shown in FIG. 5, which includes:

a data mapping control unit 501, configured to map data in a running first server to a second server;

a migrate control unit 502, configured to: after the data mapping control unit 501 maps the data of the running first server to the second server and the second server is started, migrate a user, which initiates a service request to the first server, to the second server; and

a data update control unit 503, configured to: after the migrate control unit 502 migrates the user, which initiates a service request to the first server, to the second server, update the data of the first server.

In the above solution, by mapping the data in the first server to the second server, and migrating the user, which initiates a service request to the first server, to the second server, the second server is enabled to provide a service for the user. As for a user newly initiating a service, the service thereof is not interrupted, so that the data update is smooth, and the user experience is better.

Optionally, as shown in FIG. 6, the migrate control unit 502 includes:

a migrate subunit 601, configured to: after the data mapping control unit 501 maps the data of the running first server to the second server and the second server is started, migrate a user having logged in the first server to the second server. The solution enables that a service of the user having logged in is not interrupted, so that the data update is smooth, and the user experience is better.

Optionally, the migrate subunit 601 is specifically configured to: after the data mapping control unit 501 maps the data of the running first server to the second server and the second server is started, if a user has logged in the first server but does not use a service, migrate the user directly to the second server. The solution enables that a service of the user having logged in but not using a service is not interrupted, so that the data update is smooth, and the user experience is better.

Optionally, the migrate subunit 601 is specifically configured to: after the data mapping control unit 501 maps the data of the running first server to the second server and the second server is started, if a user has logged in the first server and is using a service, migrate the user to the second server after the service provided by the first server is finished. The solution enables that a service of the user having logged in and using a service is not interrupted, so that the data update is smooth, and the user experience is better.

Optionally, the migrate subunit 601 being configured to migrate the user logged in the first server to the second server includes: configured to migrate the user to a service module in the second server the same as that of the user in the first server, and exit the user from the first user. The solution does not change the service of the user on the original server, although the server providing the service is changed, the user does not aware this, so the switch of the servers is smoother.

Optionally, the data update control unit 503 is specifically configured to: after the migrate control unit 502 migrates the user, which initiates a service request to the first server, to the second server, close all services of the first server, and start data update.

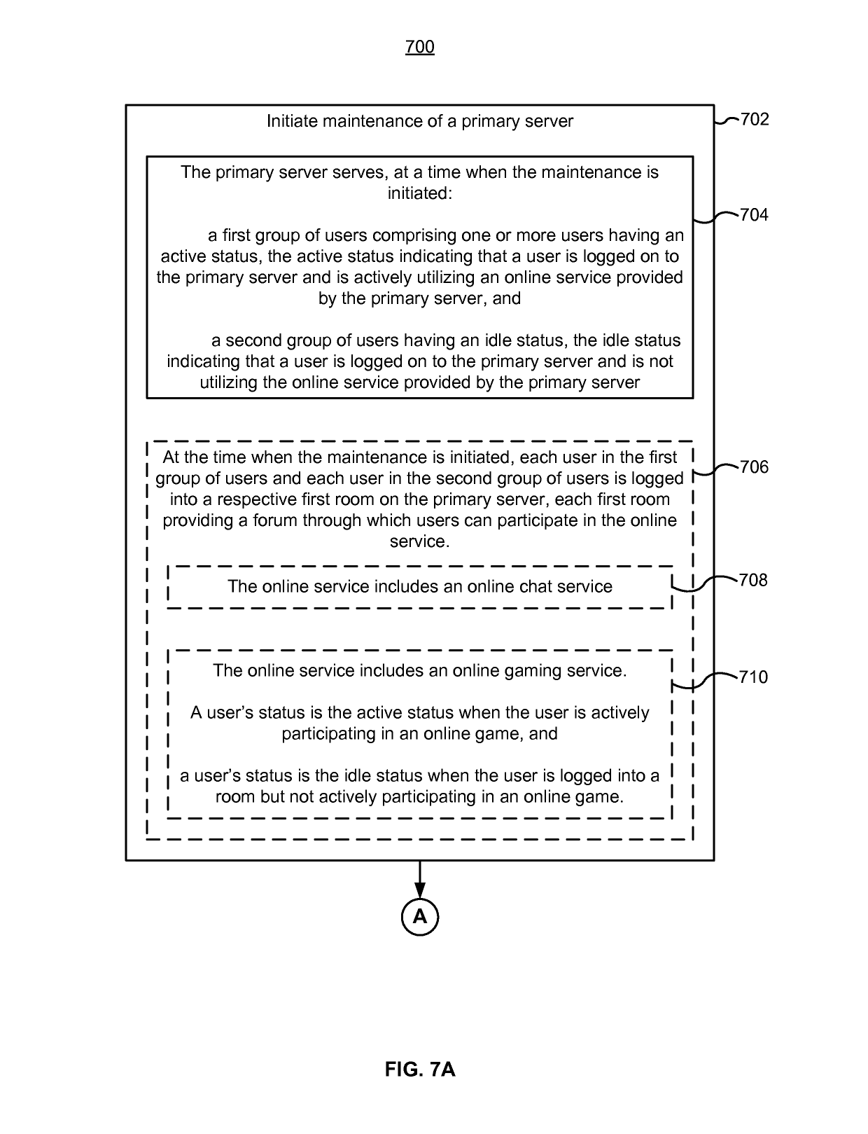

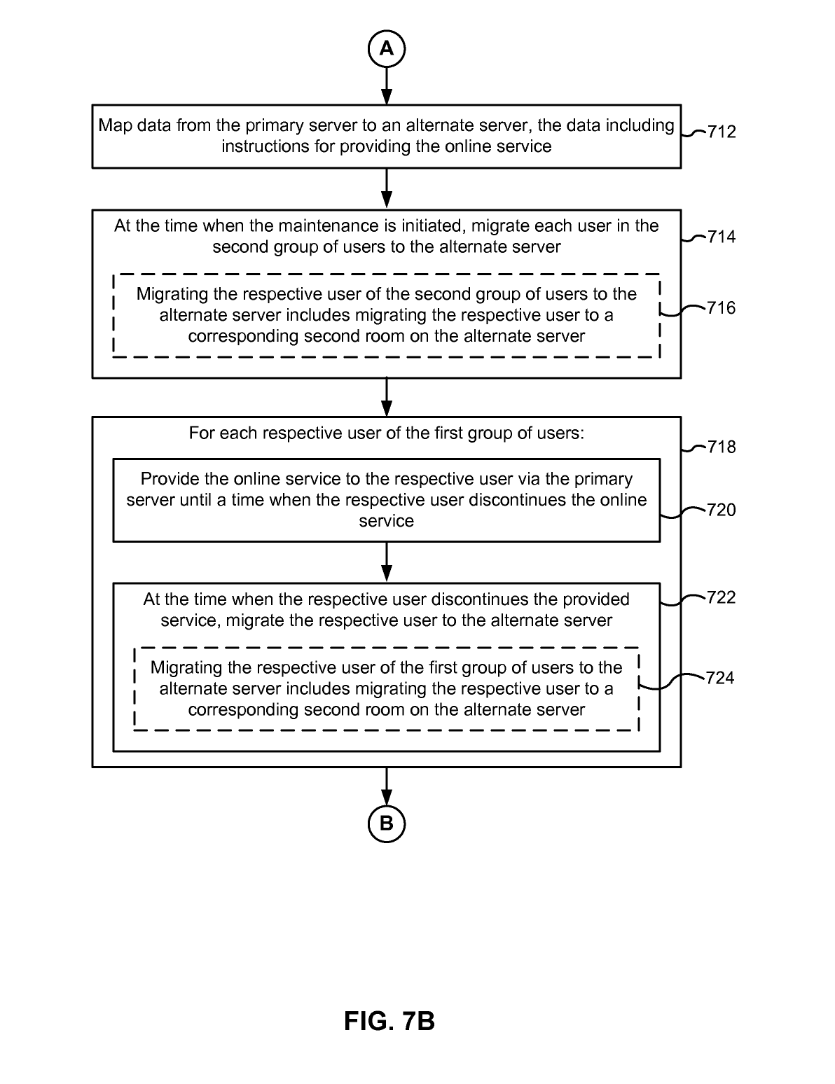

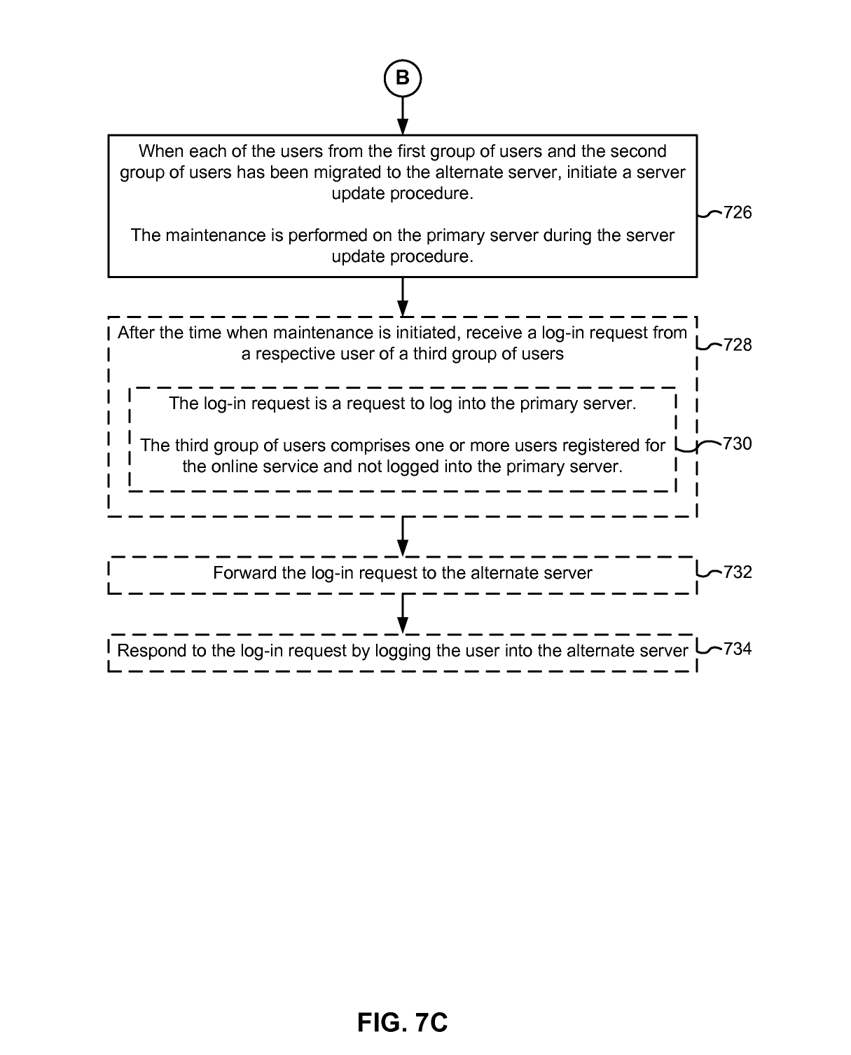

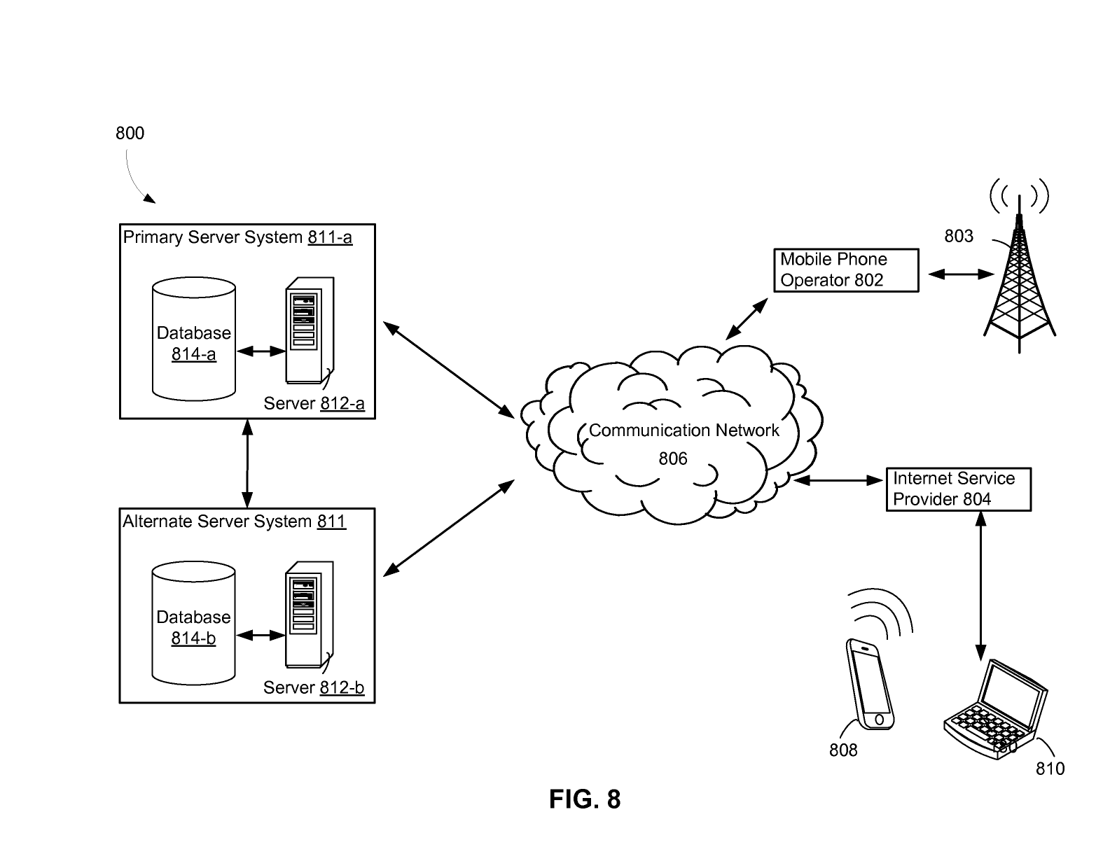

FIGS. 7A-7C is a schematic flowchart of a method 700 for updating a server, in accordance with some implementations. In some implementations, one or more of the operations described with reference to the method 700 are performed at a primary server (e.g., primary server system 811-a, FIG. 8). In some implementations, one or more of the operations described with reference to the method 700 are performed at an alternate server system (e.g., alternate server system 811-b, FIG. 8). For ease of explanation, the method 700 is described with reference to a single server system for which an alternate server and a primary server are incorporated therein.

The server system initiates (702) maintenance of a primary server. The primary server serves (704), at a time when the maintenance is initiated, a first group of users comprising one or more users having an active status. The active status indicates that a user is logged on to the primary server and is actively utilizing an online service provided by the primary server. The primary server also serves, at the time when the maintenance is initiated, a second group of users having an idle status. The idle status indicates that a user is logged on to the primary server and is not utilizing the online service provided by the primary server.

In some embodiments, at the time when the maintenance is initiated, each user in the first group of users and each user in the second group of users is (706) logged into a respective first room on the primary server. Each first room provides a forum through which users can participate in the online service. In some embodiments, the online service includes (708) an online chat service (e.g., the first rooms are chat rooms on the primary server). In some embodiments, the online service includes (710) an online gaming service (e.g., the first rooms are game rooms on the primary server). In such circumstances, a user's status is the active status when the user is actively participating in an online game, and a user's status is the idle status when the user is logged into a room but not actively participating in an online game. For example, a plurality of users may be logged into a respective first room, where users can challenge each other to a game. Provided that a respective user has not entered into a game with another user, that user's status is the idle status. Upon entering into a game with another user, the user's status changes to the active status.

The server system maps (712) data from the primary server to an alternate server, the data including instructions for providing the online service.

At the time when the maintenance is initiated, the server system migrates (714) each user in the second group of users to the alternate server. In some embodiments, migrating the respective user of the second group of users to the alternate server includes (716) migrating the respective user to a corresponding second room on the alternate server.

On the other hand, for each respective user of the first group of users (718), the server system provides (720) the online service to the respective user via the primary server until a time when the respective user discontinues the online service.

At the time when the respective user discontinues the provided service, the server system migrates (722) the respective user to the alternate server. In some embodiments, migrating the respective user of the first group of users to the alternate server includes (724) migrating the respective user to a corresponding second room on the alternate server (e.g., the second rooms on the alternate server comprise a mirrored version of the first rooms on the primary server).

For example, consider the situation of a first user competing with a second user in an online game through a respective first room of the primary server, and a third user that is idle in the respective first room. At the time when the maintenance is initiated, the third user will be migrated to a respective second room that corresponds to the respective first room. When the first user and second user discontinue the online game (e.g., because it has ended), they too will be migrated to the same respective second room. In some embodiments, mapping data (cf. operation 712) includes mapping metadata associated with the respective first room that includes, for example, a list of other players in the first room and their current status. In this manner, the migrate to the respective second room will be transparent to the third user because, for example, it will appear to the third user as if the first user and second user are in the still in the same room as the third user and unavailable because they are currently competing with one another. As soon as the first user and the second user complete their game, the first user and second user are then migrated to the respective second room, after which point they are in the same room as the third user.

When each of the users from the first group of users and the second group of users has been migrated to the alternate server, the server system initiates (726) a server update procedure. The maintenance is performed on the primary server during the server update procedure.

In some embodiments, after the time when maintenance is initiated, the server system receives (728) a log-in request from a respective user of a third group of users. The log-in request is (730) a request to log into the primary server. The server system forwards (732) the log-in request to the alternate server. The server system then responds (734) to the log-in request by logging the user into the alternate server. The third group of users comprises one or more users registered for the online service and not logged into the primary server.

FIG. 8 is a diagram of a client-server environment, in accordance with some implementations. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 800 includes one or more mobile phone operators 802, one or more internet service providers 804, and a communications network 806.

The mobile phone operator 802 (e.g., wireless carrier), and the Internet service provider 804 are capable of being connected to the communication network 806 in order to exchange information with one another and/or other devices and systems. Additionally, the mobile phone operator 802 and the Internet service provider 804 are operable to connect client devices to the communication network 806 as well. For example, a smart phone 808 is operable with the network of the mobile phone operator 802, which includes for example, a base station 803. Similarly, for example, a laptop computer 810 (or tablet, desktop, smart television, workstation or the like) is connectable to the network provided by an Internet service provider 804, which is ultimately connectable to the communication network 806.

The communication network 806 may be any combination of wired and wireless local area network (LAN) and/or wide area network (WAN), such as an intranet, an extranet, including a portion of the Internet. It is sufficient that the communication network 806 provides communication capability between client devices (e.g., smart phones 808 and personal computers 810) and servers. In some implementations, the communication network 806 uses the HyperText Transport Protocol (HTTP) to transport information using the Transmission Control Protocol/Internet Protocol (TCP/IP). HTTP permits a client device to access various resources available via the communication network 806. However, the various implementations described herein are not limited to the use of any particular protocol.

In some implementations, the client-server environment 800 further includes a primary server system 811-a and an alternate server system 811-b. Within each server system 811, there is a server computer 812 (e.g., a network server such as a web server, such as server 812-a and 812-b) for receiving and processing data received from the client device 808/810 (e.g., gaming or chat data). In some implementations, the server system 811 stores (e.g., in a database 814-a or 814-b) and maintains information corresponding to a plurality of gaming or chat rooms, user data (e.g., player rankings, metadata, etc.), and the like. In some embodiments, server systems 811-a and 811-b are combined into a single server system (e.g., with a primary server computer and an alternate server computer).

In some implementations, the primary server system 811-a is updated (e.g., undergoes maintenance) in the following manner: maintenance of the primary server system 811-a is initiated. At the time when the maintenance is initiated, the primary server system 811-a serves a first group of users (e.g., users of a device 808/810) comprising one or more users having an active status. The active status indicates that a user is logged on to the primary server system 811-a and is actively utilizing an online service provided by the primary server system 811-a (e.g., a gaming service or a chat service). At the time when the maintenance is initiated, the primary server system 811-a also serves a second group of users having an idle status. The idle status indicates that a user is logged on to the primary server system 811-a and is not utilizing the online service provided by the primary server system 811-a (e.g., the user is logged on but is not currently participating in a game provided by the gaming service). Data that include instructions for providing the online service are mapped from the primary server system 811-a to an alternate server system 811-b. At the time when the maintenance is initiated, each user in the second group of users is migrated to the alternate server.

On the other hand, for each respective user in the first group of users, the online service continues to be provided to the respective user via the primary server system 811-a until a time when the respective user discontinues the online service. At this point, the respective user is then migrated to the alternate server system 811-b. When all of the users from the first group of users and the second group of users have been migrated to the alternate server system 811-b, a server update procedure is initiate. The maintenance is performed on the primary server system 811-a during the server update procedure.

Those skilled in the art will appreciate from the present disclosure that any number of such devices and/or systems may be provided in a client-server environment, and particular devices may be altogether absent. In other words, the client-server environment 800 is merely an example provided to discuss more pertinent features of the present disclosure. Additional server systems, such as domain name servers and client distribution networks may be present in the client-server environment 800, but have been omitted for ease of explanation.

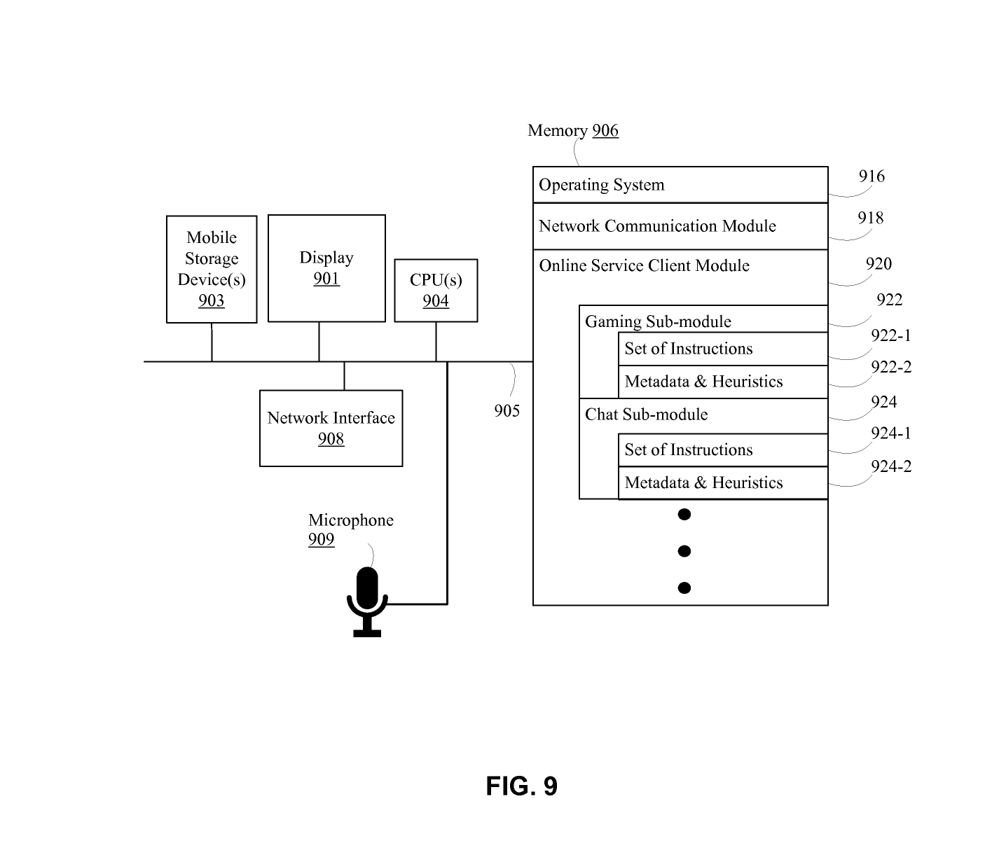

FIG. 9 is a diagram of an example implementation of the device 808/810, in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, the device 808/810 includes one or more processing units (CPU's) 904, one or more network or other communications interfaces 908, a display 901, memory 906, a microphone 909, one or more mobile storage devices 903, and one or more communication buses 905 for interconnecting these and various other components. The communication buses 905 may include circuitry (sometimes called a chipset) that interconnects and controls communications between system components. Memory 906 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 906 may optionally include one or more storage devices remotely located from the CPU(s) 904. Memory 906, including the non-volatile and volatile memory device(s) within memory 906, comprises a non-transitory computer readable storage medium.

In some implementations, memory 906 or the non-transitory computer readable storage medium of memory 906 stores the following programs, modules and data structures, or a subset thereof including an operating system 916, a network communication module 918, and an online service client module 920.

The operating system 916 includes procedures for handling various basic system services and for performing hardware dependent tasks.

The network communication module 918 facilitates communication with other devices via the one or more communication network interfaces 908 (wired or wireless) and one or more communication networks, such as the internet, other wide area networks, local area networks, metropolitan area networks, and so on.

In some implementations, the online service client module 920 includes a gaming sub-module 922. In some embodiments, the gaming sub-module 920 is a mobile application through which users compete against other users in online games (e.g., via communications network 806). To this end, the online service sub-module 920 includes a set of instructions 922-1 (e.g., for displaying a user interface on the display 901, receiving user inputs, etc.) and, optionally, metadata 922-2. In some implementations, the online service module 920 includes a chat sub-module 924 having a set of instructions 924-1 (e.g., for chatting in a chat room with other users via communications network 806) and, optionally, metadata 924-2.

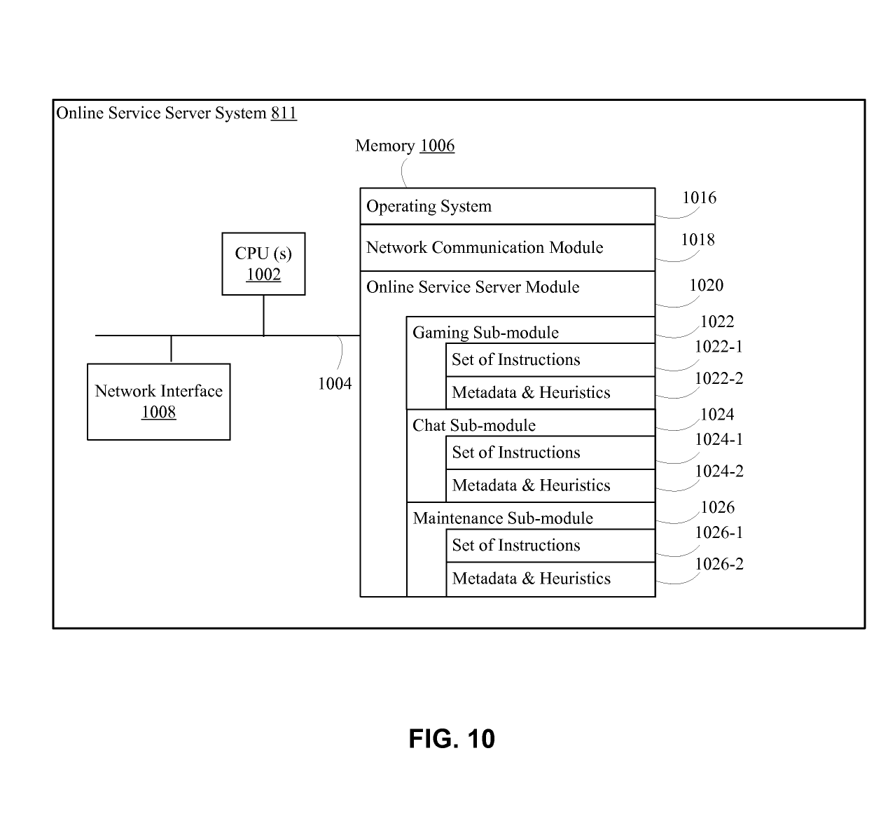

FIG. 10 is a block diagram illustrating a server system 811, discussed above with reference to FIG. 8, in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, the server system 811 includes one or more processing units (CPU's) 1002, one or more network or other communications interfaces 1008, memory 1006, and one or more communication buses 1004 for interconnecting these and various other components. The communication buses 1004 may include circuitry (sometimes called a chipset) that interconnects and controls communications between system components. Memory 1006 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1006 may optionally include one or more storage devices remotely located from the CPU(s) 1002. Memory 1006, including the non-volatile and volatile memory device(s) within memory 1006, comprises a non-transitory computer readable storage medium.

In some implementations, memory 1006 or the non-transitory computer readable storage medium of memory 1006 stores the following programs, modules and data structures, or a subset thereof including an operating system 1016, a network communication module 1018, an online service server module 1020.

The operating system 1016 includes procedures for handling various basic system services and for performing hardware dependent tasks.

The network communication module 1018 facilitates communication with other devices (e.g., other server systems 811 as well as client devices 808/810) via the one or more communication network interfaces 1008 (wired or wireless) and one or more communication networks, such as the Internet, other wide area networks, local area networks, metropolitan area networks, and so on.

The online service server module 1020 is configured to provide an online service to users (e.g., users of a device 808/810). To that end, the online service server module 1020 optionally includes one or more sub-modules, each including a set of instructions and optionally including metadata. For example, in some implementations, the online service server module 1020 may provide an online gaming service to one or more clients 808/810 using a gaming sub-module 1022 (which includes a set of instructions 1022-1 and metadata 1022-2), or may provide an online chat service to one or more clients 808/810 using a chat sub-module 1024 (which includes a set of instructions 1024-1 and metadata 1024-2). The online service server module 1020 also includes a maintenance sub-module 1026 (which includes a set of instructions 1024-1 and metadata 1024-2) that facilitates the server maintenance methods described herein (e.g., method 700 described with reference to FIGS. 7A-7C).

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of performing server maintenance, comprising:
initiating maintenance of a primary server while the primary server is serving:
a first group of users having an active status, the active status indicating that a user is logged on to the primary server and is actively utilizing an online service provided by the primary server; and
a second group of users having an idle status, the idle status indicating that a user is logged on to the primary server and is currently not utilizing the online service provided by the primary server;
mapping data from the primary server to an alternate server, the data including instructions for providing the online service;
at the time when the maintenance is initiated, migrating each user in the second group of users to the alternate server;
for each respective user in the first group of users:
providing the online service to the respective user via the primary server until a time when the respective user discontinues the online service; and
at the time when the respective user discontinues the provided service, migrating the respective user to the alternate server;
when each of the users from the first group of users and the second group of users has been migrated to the alternate server, initiating a server update procedure, wherein the maintenance is performed on the primary server during the server update procedure.

2. The method of claim 1, further including:
after the time when maintenance is initiated, receiving a log-in request from a respective user of a third group of users, wherein:
the log-in request is a request to log into the primary server; and
the third group of users comprises one or more users registered for the online service and not logged into the primary server;
forwarding the log-in request to the alternate server; and
responding to the log-in request by logging the user into the alternate server.

3. The method of claim 1, wherein mapping the data from the primary server to the alternate server includes copying recorded data from the primary server to the alternate server.

4. The method of claim 1, wherein at the time when the maintenance is initiated, each user in the first group of users and each user in the second group of users is logged into a respective first room on the primary server, each first room providing a forum through which users can participate in the online service.

5. The method of claim 4, wherein:
migrating the respective user of the first group of users to the alternate server includes migrating the respective user to a corresponding second room on the alternate server; and
migrating the respective user of the second group of users to the alternate server includes migrating the respective user to a corresponding second room on the alternate server.

6. The method of claim 4, wherein the online service includes an online chat service.

7. The method of claim 4, wherein the online service includes an online gaming service.

8. The method of claim 7, wherein:
a user's status is the active status when the user is actively participating in an online game; and
a user's status is the idle status when the user is logged into a room but not actively participating in an online game.

9. A server system, comprising:
one or more processors;
memory; and
one or more programs, wherein the one or more programs are stored in memory and configured to be executed by the one or more processors, the one or more programs including an operating system and instructions that when executed by the one or more processors cause the electronic device to:
initiate maintenance of a primary server while the primary server is serving:
a first group of users having an active status, the active status indicating that a user is logged on to the primary server and is actively utilizing an online service provided by the primary server; and
a second group of users having an idle status, the idle status indicating that a user is logged on to the primary server and is currently not utilizing the online service provided by the primary server;
map data from the primary server to an alternate server, the data including instructions for providing the online service;
at the time when the maintenance is initiated, migrate each user in the second group of users to the alternate server;
for each respective user in the first group of users:
provide the online service to the respective user via the primary server until a time when the respective user discontinues the online service; and
at the time when the respective user discontinues the provided service, migrate the respective user to the alternate server;
when each of the users from the first group of users and the second group of users has been migrated to the alternate server, initiate a server update procedure, wherein the maintenance is performed on the primary server during the server update procedure.

10. The server system of claim 9, the instructions further causing the server system to:
after the time when maintenance is initiated, receive a log-in request from a respective user of a third group of users, wherein:
the log-in request is a request to log into the primary server; and
the third group of users comprises one or more users registered for the online service and not logged into the primary server;
forward the log-in request to the alternate server; and
respond to the log-in request by logging the user into the alternate server.

11. The server system of claim 9, wherein mapping the data from the primary server to the alternate server includes copying recorded data from the primary server to the alternate server.

12. The server system of claim 9, wherein prior to the time when the maintenance is initiated, each user in the first group of users and each user in the second group of users is logged into a respective first room on the primary server, each first room providing a forum through which users can participate in the online service.

13. The server system of claim 12, wherein:
migrating the respective user of the first group of users to the alternate server includes migrating the respective user to a corresponding second room on the alternate server; and
migrating the respective user of the second group of users to the alternate server includes migrating the respective user to a corresponding second room on the alternate server.

14. The server system of claim 12, wherein the online service includes an online chat service.

15. The server system of claim 12, wherein the online service includes an online gaming service.

16. The server system of claim 15, wherein:
a user's status is the active status when the user is actively participating in an online game of the online gaming service; and
a user's status is the idle status when the user is logged into a room but not actively participating in an online game of the online gaming service.

17. A non-transitory computer readable storage medium storing one or more programs, the one or more programs comprising instructions, which when executed by server system with one or more processors and memory, cause the server system to:
initiating maintenance of a primary server while the primary server is serving:
a first group of users having an active status, the active status indicating that a user is logged on to the primary server and is actively utilizing an online service provided by the primary server; and
a second group of users having an idle status, the idle status indicating that a user is logged on to the primary server and is currently not utilizing the online service provided by the primary server;
map data from the primary server to an alternate server, the data including instructions for providing the online service;
at the time when the maintenance is initiated, migrate each user in the second group of users to the alternate server;
for each respective user of the first group of users:
provide the online service to the respective user via the primary server until a time when the respective user discontinues the online service; and
at the time when the respective user discontinues the provided service, migrate the respective user to the alternate server;
when each of the users from the first group of users and the second group of users has been migrated to the alternate server, initiate a server update procedure, wherein the maintenance is performed on the primary server during the server update procedure.

18. The non-transitory computer readable storage medium of claim 17, wherein the instructions further cause the server system to:
after the time when maintenance is initiated, receive a log-in request from a respective user of a third group of users, wherein:
the log-in request is a request to log into the primary server; and
the third group of users comprises one or more users registered for the online service and not logged into the primary server;
forward the log-in request to the alternate server; and
respond to the log-in request by logging the user into the alternate server.

19. The non-transitory computer readable storage medium of claim 17, wherein mapping the data from the primary server to the alternate server includes copying recorded data from the primary server to the alternate server.

20. The non-transitory computer readable storage medium of claim 17, wherein prior to the time when the maintenance is initiated, each user in the first group of users and each user in the second group of users is logged into a respective first room on the primary server, each first room providing a forum through which users can participate in the online service.
